(19) United States
(12) Patent Application Publication
(10) Pub. No.: US 2006/0206626 A1
(43) Pub. Date: Sep. 14, 2006

(54) Instrument and communications controller for instrument

(76) Inventor: Peter T. Sleeman, Horndean (GB)

Correspondence Address: Don W. Bulson, Esq.;Renner, Otto, Boisselle & Sklar, P.L.L., 1621 Euclid Ave., 19th Floor, Cleveland, OH, 44115, US

(21) Appl. No.: 11/338,101

(22) Filed: Jan. 24, 2006

(30) Foreign Application Priority Data
Mar. 8, 2005 (GB) GB 0504780.8

(51) Int. Cl. G06F 3/00

(52) U.S. Cl. 710/5

(57) ABSTRACT

A communications controller for an instrument connectable to a host computer via a bus. The controller is operable to control communications between the instrument and the host computer according to an address-based protocol for a dedicated bus specification. The controller is operable to respond to a received synchronization command having an address allocated to another instrument, by initiating a synchronization operation for synchronizing the instrument with the other instrument. A single synchronization command synchronizes multiple instruments, allowing a high degree of synchronization concurrence. An instrument for use with a host computer. The instrument includes a bus connector configured to connect the instrument to a dedicated bus segment for communicating with the host computer, and a synchronization connector for communicating a synchronization signal with another instrument. The instrument is operable to synchronize with the other instrument using the synchronization signal. Synchronization signals pass between multiple instruments. A high degree of synchronization concurrence is achievable.

### BACKGROUND OF THE INVENTION

This invention relates to an instrument and to a communications controller for an instrument.

Devices such as printers, keyboards, mice, cameras, network adapters etc. are known as peripheral devices.

Peripheral devices can be connected to a host computer system using a bus. For example, the Universal Serial Bus (USB) has become an industry standard. USB is ideally suited for these purposes, offering a near optimal balance of high performance and low cost.

It is known to provide a bus specification which uses a point-to-point “tree” bus topology. In this topology, each device connects to the host or its hub port via its own dedicated bus segment, and all segments “radiate” outwards from a primary port at a host computer toward attached devices. The bus segments are like the branches of a tree and the attached devices are like the leaves at the end of these branches. The USB specification employs this topology.

A USB also constitutes an example of a half-duplex differential interface. These allow signals to be sent or received on the bus, although it is not possible for signals to be sent and received simultaneously. A USB also supplies power and ground to an attached device, and accordingly includes a total of four wires.

The communication protocol used by the topology described above can be based on host-initiated broadcasts, with an attached device address being embedded in the protocol. Communications between the host and the attached device are thus address based. For example, an address for a device can be of the form “AnEx” (this is shorthand for “Address 0, Endpoint 0” (an Endpoint is simply an internal address for a device and can be thought of like a register address; each device can have up to 16 Endpoints ranging from 0 to 15). These addresses can be assigned to the different devices attached to a host computer when the host computer starts up. “Hot plugging” can allow addresses to be assigned when the host is already switched on. In this protocol, each device is assigned a unique address to which only that device responds. Accordingly, all attached devices are uniquely addressable, meaning that each one will only respond to a USB command issued from the host if the address field in the command matches its assigned address. The USB uses such a protocol.

In accordance with this addressing method, the USB (for example) is a broadcast bus, whereby commands issued from the host reach all enabled USB devices even if they are connected to the host via one or more hubs, so giving all devices a chance to respond if the address matches theirs. For communications in the reverse direction i.e. from device to host, the bus is not broadcast in nature. Each device is connected via its own dedicated bus segment so any bus traffic originating at the device will propagate toward the host without any other connected device being able to see this traffic.

As used herein, the term instrument refers to a device such as a measurement or control device. Instruments can be configured as peripheral devices. Examples of instruments include Oscilloscopes, Logic Analyzers, Function Generators and PID Controllers, as well as data acquisition systems such as Digital Multi-Meters, Temperature Loggers, Voltage Loggers, Strain Measurement, Humidity Loggers and Vibration Recorders etc.

In the field of electronic instrumentation, there is commercial advantage in offering instruments with a connection to a bus of the kind described above (e.g. USB), and many such devices are commercially available. Clearly, with the USB being a prolific industry standard bus and with personal computers featuring more prominently as hosts for such instruments, offering USB connected instruments expands the potential market for such instruments and also carries potential cost savings for the instrument manufacturer by leveraging the low cost and easy availability of USB interface components (connectors, cables, silicon devices, software etc).

It is known to provide an instrument which connects to a USB. These known instruments can all be classed as “self-contained”, that is, they are organized as a housing containing the instrument electronics, and having a USB connection and one or more instrument inputs or outputs to connect to an item being measured or controlled.

FIG. 1 shows such a instrument 104. The instrument 104 is connected to a host computer 100 via a USB 103 and appears to the computer as one or more measurement or control channels 102. The instrument includes three inputs/outputs 107 for connecting 105 to an item 106 being measured or controlled. Software 101 running on the host computer 100 can be used to configure, control and monitor the instrument 104, and to recover measurement data from the unit under test 106. The host software 101 is responsible for rendering the measurements on the host computer's screen 101. In this way, some of the functionality provided by a traditional instrument (an oscilloscope, for example), is provided not by the instrument, but by the host computer. This reduces costs relative to a more traditional instrument, by using the processing and display capabilities of the host computer 100, and indeed by allowing extra features such as recording, analyzing and automation functions to also be provided by the host computer 100.

Some known instruments provide more than one channel in a single device. However, from a commercial perspective, offering a one-channel instrument (for example, a one channel oscilloscope) has the advantage that the entry-level selling price can be reduced relative to offering a two or more channel scope, due to the reduced complexity and component count. For the same reasons, a one channel oscilloscope is also intrinsically lower powered and physically smaller than a similar oscilloscope offering two or more channels.

It would be desirable to allow multiple single channel instruments to connect to a host computer using a bus topology such as that described above (for example, USB), since then instrumentation including multiple instruments having the single-channel advantages described above could be used to form a modular, multi-channel, instrument.

However, there exists a shortcoming in specifications such as the USB specification that make them less than ideal for instrumentation uses where multiple instruments are desired. These shortcomings relate to the inability of specifications such as the USB specification to provide for synchronization between the different instruments. For example, it is often desirable to be able to measure two channels or more concurrently so that a correlated relationship between one channel and the other can be observed. High-speed instruments will tend to need to synchronize within very tight limits of perhaps just a few nanoseconds. Medium-speed instruments may only need synchronization to within a few microseconds. Present instruments using specifications such as the USB specification are unable to provide this functionality.

Because bus topologies such as those described above (e.g. USB) employ time-shared buses, with available bandwidth being shared out between all connected devices, it is virtually impossible to guarantee that commands to several instruments will arrive with a deterministic skew or arrival order.

So it can be seen that there are distinct commercial advantages in offering an instrument such as a one-channel oscilloscope for the specifications such as the USB, but that the synchronization problems associated with making a modular system so that a plurality of identical instruments can be combined to act as though it was a single multi-channel instrument, are non-trivial. The same commercial benefits of modularity can also be applied to other instruments, examples of which were cited earlier. Known bus specifications such as those described above have no means of providing synchronization to allow this desired modularity. Instead they tend to be either single channel non-expandable devices or have a plurality of channels and deal with all such synchronization matters internally and so have no need for a means of expandability (they are already multi-channel).

There exist methods to deal with synchronization matters for buses like PCI, VXI, PXI, GPIB etc. FIG. 2 shows a plurality of instruments 305 connected to a host computer 300 using one such bus 302. The host computer includes software 301, for controlling the instruments 305. Connections 306 connect the instruments 305 to an item 307 to be tested.

With buses 302 of this kind, specific additions to the electrical bus interface have been made by industry working groups, to allow a plurality of instruments 305 connected in parallel on the bus. It is important to note that parallel bus topologies differ from the “tree” bus topologies described above at least insofar as the former does not involve the use of dedicated bus segments for each attached device. Instead, the devices are attached to a common bus (in parallel) provided, for example, on a back-plane. Often, synchronization is by means of dedicated signals that are passed between all instruments 305 across the electrical back-plane 304. Again, it should be stressed that such buses 302 are of a parallel and shared nature, with each instrument 305 connected to the same electrical signals as the other instruments 305. Typically there is a master bus control module 303 that drives the back-plane 304 and forms the connection to the host computer 302. This means that synchronization information is can be shared with minimal arrival skew.

However, with specifications such as the USB specification, there is no way to deliver precise synchronization information between instruments. While systems are commercially available that include a USB connection, these connections are not responsible for the primary control of each instrument. That is to say, the USB interface is used to perform the overall instrument control and monitoring, but the actual bus arriving at each instrument is not USB. An example of this is a PXI instrument rack. Each instrument in this kind of rack is specifically equipped with a PXI bus connector and draws all its communications from the bus. There also exists a bus controller that connects to the host via USB and acts as a USB to PXI bridge.

### SUMMARY OF THE INVENTION

An aspect of the invention provides a communications controller for an instrument connectable to a host computer via a bus. The communications controller is operable to control communications between the instrument and the host computer according to an address-based protocol for a dedicated bus specification. The communications controller is also operable to respond to a received synchronization command having an address allocated to another instrument, by initiating a synchronization operation for synchronizing the instrument with the other instrument.

A controller according to this aspect is thus able to respond to commands, and in particular to synchronization commands, even when the synchronization command is addressed to another instrument. In this way, multiple discrete instruments can respond to a single synchronization command to perform a synchronization operation, even where a dedicated bus specification with an address-based protocol is used. Since a single synchronization command can be used to synchronize multiple instruments, synchronization can be provided with a higher degree of concurrence.

Examples of synchronization commands which may advantageously be used include a command which identifies a trigger event to allow multiple instruments to trigger simultaneously (as specified, for example, by the host computer), and a command including a time indicator for synchronizing a clock of the controllers.

This scheme can be expanded to allow the controller to respond to more than one address which is not strictly allocated to the instrument. This provides a high degree of flexibility in selecting an appropriate synchronization operation by the user. For example, different synchronization operations can be associated to different addresses, or addresses can be used to create groups and sub-groups of instruments. On a similar theme, the synchronization commands can be divided into different classes, so the controller can distinguish between, for example, synchronization commands having the same address but directed to different synchronization operations.

The controller can keep a record of the addresses to which it should (and should not) respond using a table with address entries indicating the alias addresses. For example, the entries in the table could match addresses and/or command classes to specific groups of instruments and/or specific synchronization operations.

An example of a dedicated bus specification is a Universal Serial Bus (USB) specification.

According to another aspect of the invention there is provided a method for controlling communications via a bus, comprising: controlling communications between an instrument and a host computer according to an address-based protocol for a dedicated bus specification; and responding to a received synchronization command having an address allocated to another instrument, by initiating a synchronization operation for synchronizing the instrument with the other instrument.

According to another aspect of the invention there is provided an including a bus connector and a controller as described above.

According to a further aspect of the invention there is provided a computer program product including instructions executable on an instrument to implement the controller described above.

Synchronization can be effected by direct communication (i.e. not via the host computer, or any driver software present on the host computer, for example) between multiple instruments.

According to another aspect of the invention, there is provided an instrument for use with a host computer. The instrument includes a bus connector configured to connect the instrument to a dedicated bus segment for communicating with the host computer. The instrument also includes a synchronization connector for communicating a synchronization signal with another instrument. The instrument is operable to synchronize with the other instrument using the synchronization signal.

The synchronization connector provides a means by which synchronization signals can pass between multiple instruments without having to be conveyed via a dedicated bus segment. This allows synchronization signals to pass directly between multiple instruments, whereby a high degree of synchronization concurrence is achievable. This also allows the instruments to synchronize independently of the host computer.

An instrument can be operable to be configured as a master instrument and/or a slave instrument. This allows one of the instruments in a group of instruments to take responsibility for producing the synchronization signal. Slave instruments synchronize themselves according to the synchronization signal, thereby aligning themselves with the master instrument.

Examples of synchronization signals which may advantageously be used include a timing signal for synchronizing a clock of each instrument, or a signal which identifies a trigger event to allow multiple instruments to trigger (e.g. for data collection) simultaneously (as specified, for example, by the master instrument).

More than one synchronization connector can be provided to increase bandwidth between the instruments for the communication of synchronization signals.

The bus connector can be a Universal Serial Bus (USB) connector.

According to a further aspect of the invention, there is provided an instrument controller for an instrument of the kind described above. The instrument controller is configured to communicate a synchronization signal with an instrument controller of another instrument. The instrument controller is also configured to synchronize with the instrument controller of the other instrument using the synchronization signal.

The instrument controller can be implemented using a computer program.

According to a another aspect of the invention, there is provided a back-plane for receiving a plurality of instruments of the kind described above. The back-plane includes a plurality of bus connectors and a plurality of respective synchronization connectors for receiving corresponding bus and synchronization connectors of the instruments. The synchronization connectors of the back-plane are interconnected for conveying synchronization signals between received instruments.

According to a another aspect of the invention, there is provided a method comprising: connecting a first instrument through a bus connector to a dedicated bus segment communicating with a host computer; and communicating a synchronization signal with a second instrument through a synchronization connector, wherein the first instrument synchronizes with the second instrument using the synchronization signal.

A computer system can be built up by combining the various elements described above. It should be noted that instruments according to this invention can include a combination of the communications controller and synchronization connections, as will be apparent from the following description of specific examples.

A computer program product for implementing the invention can be in the form of a computer program on a carrier medium. The carrier medium could be a storage medium, such as a solid state, magnetic, optical, magneto-optical or other storage medium. The carrier medium could be a transmission medium such as broadcast, telephonic, computer network, wired, wireless, electrical, electromagnetic, optical or indeed any other transmission medium.

### BRIEF DESCRIPTION OF THE DRAWINGS

Exemplary embodiments of the present invention will be described hereinafter, by way of example only, with reference to the accompanying drawings in which like reference signs relate to like elements and in which:

FIG. 1 shows an instrument connected to a host computer according to a known arrangement;

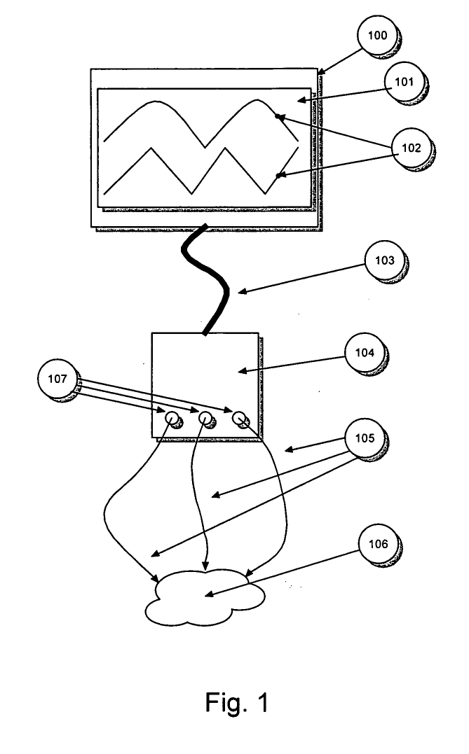

FIG. 2 shows a plurality of instruments connected to a host computer according to a known arrangement;

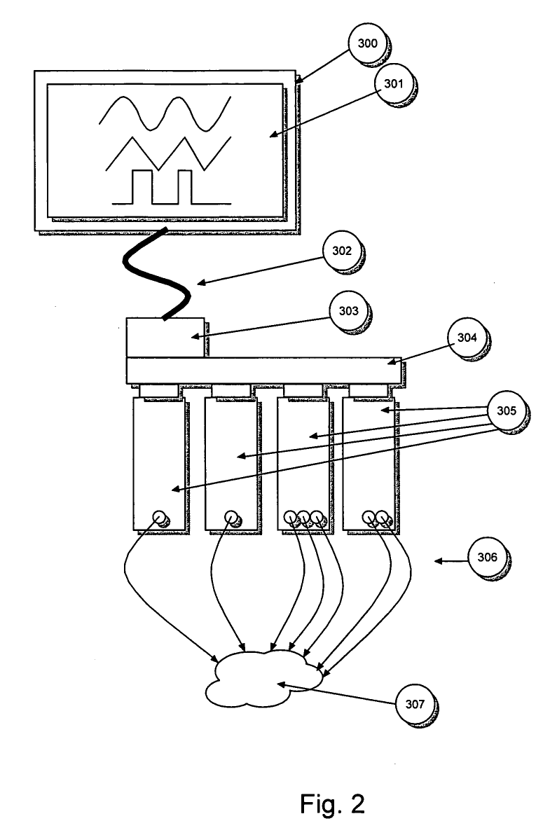

FIG. 3 shows an instrument in accordance with an embodiment of the invention;

FIG. 4 shows a plurality of instruments connected to a host computer in accordance with an embodiment of the invention;

FIG. 5 shows a plurality of instruments connected to a host computer in accordance with an embodiment of the invention;

FIG. 6 shows a back plane for connection to a plurality of instruments in accordance with an embodiment of the invention.

### DESCRIPTION OF PARTICULAR EMBODIMENTS

Exemplary embodiments of the present invention are described in the following with reference to the accompanying drawings.

Embodiments of this invention allow multiple discrete instruments connected to a host computer to be synchronized.

Synchronization can include, for example, synchronizing to an internal clock of one or more of the discrete instruments, or synchronizing the initiation of data collection by the instrument according to a common trigger event determined by the host computer or by one of the instruments.

Embodiments of this invention allow synchronization information to be conveyed between discrete instruments to allow those instruments to be combined in a modular way. This allows each discrete instrument to work independently for most of its operation but also and significantly, to work together with other instruments in the system with a high level of timing concurrency. This can allow a compound instrument to be formed, which uses simpler interconnected discrete instruments (for example, single channel instruments) to combine the number of control or measurement channels available to the host system, so that together they act as a single higher channel count instrument.

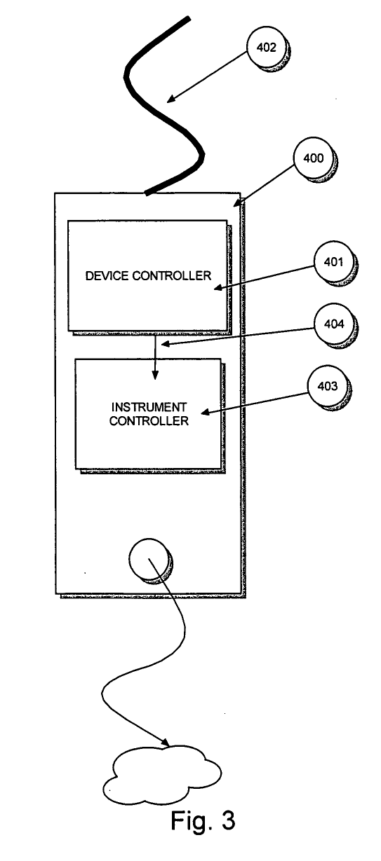

Embodiments of the invention use a bus topology including dedicated bus segments (e.g. USB) to convey synchronization information. FIG. 3 shows an instrument 400 in accordance with one such embodiment.

In this embodiment, a discrete instrument 400 includes a device controller 401 that can deal with the electrical and protocol aspects of a USB 402 to which the instrument 400 is connected. As described previously, a USB uses a broadcast method together with a device addressing method to be able to send commands specifically to one attached device. While the USB host broadcasts a timing beacon that can be received by all attached devices, the beacon does not convey any specific information that could be used to affect concurrency of operation of the type required for this instrumentation application. Only an incrementing frame count is transmitted on a precise 1 ms interval. The device controller 401 in this embodiment includes a means to configure an “alias” address making the controller 401 operable to receive commands at its normal configured address n (where the address of the instrument 400 is of the form AnEx as described above), but also to receive specific alias commands at another address, namely address w. Commands received using the extra address can be used to convey synchronization information 404 to the instrument controller 403.

In this context, the instrument controller 403 can be a device inside a discrete instrument 400, which handles the timing and control of the instrument 400 and its acquisition or output control functions. The instrument controller 400 can be operable, using a locally generated timing clock source, which is used internally to sequence the events associated with the instrument's 400 function. For example, an instrument such as an oscilloscope would typically require a clock to control an internal analogue-to-digital converter device, to affect data capturing from same, to control the movement of the data into a local memory, and to synchronize external events operable to trigger or gate the oscilloscope's capture and acquisition functions etc. By conveying synchronization information/signals 404 to the instrument controller 403, the instrument controller 403 can be configured to synchronize itself according to, for example, the clock of another discrete instrument, or to a trigger event determined by a host computer or another discrete instrument.

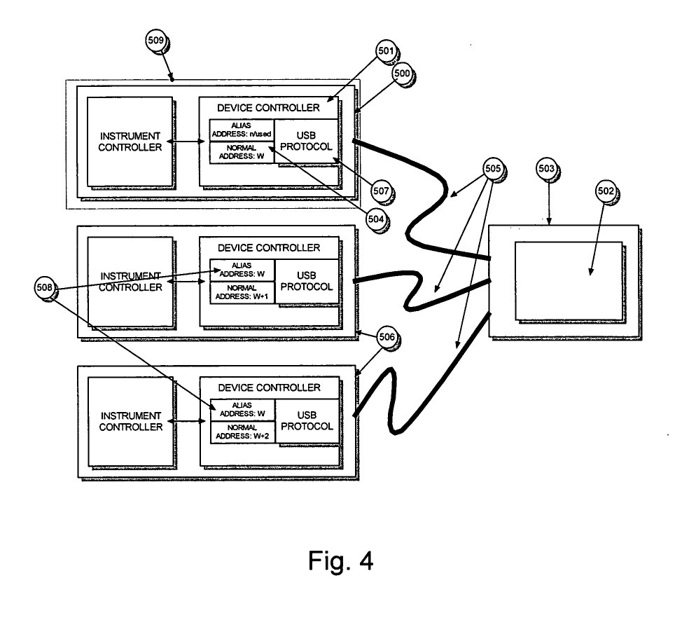

FIG. 4 shows a plurality of discrete instruments 500, 506 of the kind described in relation to FIG. 3. In this embodiment, the plurality of discrete instruments 500 are connected to a host computer 503 using respective USBs 505. Each device controller in the system includes a USB protocol controller, which manages incoming and outgoing communications on the USB 505 for that instrument 500, 506. This management function includes processing commands according to the addressing protocol described above.

The device controller 501 in the instrument 500, having had its USB protocol controller 507 configured with an assigned address in the normal way as described above, is placed under the control of a software instrument driver 502 running in the host computer 503. The software is operable to detect and control the plurality of discrete instruments 500, 506 using such a modified USB device controller, and is hence suitable to be treated as a compound instrument. The software instrument driver 502, noting that more than one compoundable USB instrument is present, arbitrarily selects one of them to be a “master” instrument. In this example, the instrument 500 is selected to be the master instrument, as denoted by the box labeled 509 in FIG. 4. The software instrument driver 502 notes the master instrument's “normal” unique device address, w 504, on the USB 505 connected to that instrument. The software instrument driver 502 then configures the remaining instruments 506 using USB commands sent to “normal” addresses of w+1, w+2 for example (which, in this example, are the normal addresses assigned to the respective remaining instruments), to inform each that it should listen for a special command or commands addressed to an alias address 508 of w (so matching the master device's “normal” assigned address.

When such a special command (referred to herein as a synchronization command) is sent to address w, it is broadcast on all of the USBs as described above. Only the instrument 500 (the “master” instrument) at address w responds on the USB in the normal way described above. However, the remaining instruments 506 “snoop” the same command and extract some meaningful instruction from the command. In this way, the broadcast nature of commands flowing from the host to devices is extended to allow a single command to be sent and subsequently decoded in an essentially concurrent way by multiple devices.

Note that due to differing propagation delays in the transmittal of the command to each device caused by hubs and cables etc, the exact arrival time of the synchronization commend may be skewed. However, using the approach described here, a single command is operable to place all discrete instruments 500, 506 in the system into a particular state at a time that has controlled and relatively small skew.

An example of a synchronization command causes the discrete instruments 500, 506 to be placed into an “acquire” state ready to capture external signals applied to measuring channels of each device. This is advantageous over having to rely on a separate USB command per discrete instrument (as would be necessary using known systems) to get the overall compound instrument into an overall acquire state, since the latter would run the risk that some discrete instruments would start acquiring substantially later than other discrete instruments. This is because there is no way to guarantee when each command will be transmitted on the bus, the USB being a time-shared bus. Using the broadcast command would allow the acquire state to be configured at almost the same instant in each discrete instrument so reducing this configuration skew to acceptable limits.

In one embodiment of this invention, the protocol controller 507 can accept an extra configurable device alias address field 508. This field 508 can be configured by the host driver 502, using a command sent to the instrument's regular address.

Optionally, the protocol controller 507 could be further configured by similar means to be sensitive only to particular classes of command sent to the alias address. This would allow greater selectivity for the internal usage of the alias address and could allow logical groupings of devices to be commanded independently.

The protocol controller 507 could be effected using, for example, hardwired means, or by using modified firmware running on an embedded controller, or by purely software means.

In one embodiment, the alias address field for each instrument could be configured using a plurality of user-accessible switches connected to each instrument. In another embodiment, the alias address could be permanently hardwired inside the protocol controller, and use an address that was considered safe against the likelihood of accidental activation, perhaps near the top of the possible device address range.

For each of the above embodiments it should be understood that a single alias address could also be replaced by a plurality of alias addresses, with each being used to control some aspect of the instruments internal operation, and also allowing groups of instruments to be synchronously addressed.

The example described above allows compound acquisition of, for example, measurement data, using a plurality of discrete instruments, and offers a great advantage in that a single command can change the state of several discrete instruments with synchronization commands arriving at the instruments with a relatively closely matched skew.

However, it will be evident that closely matched configuration concurrency alone in some cases may not be sufficient by itself.

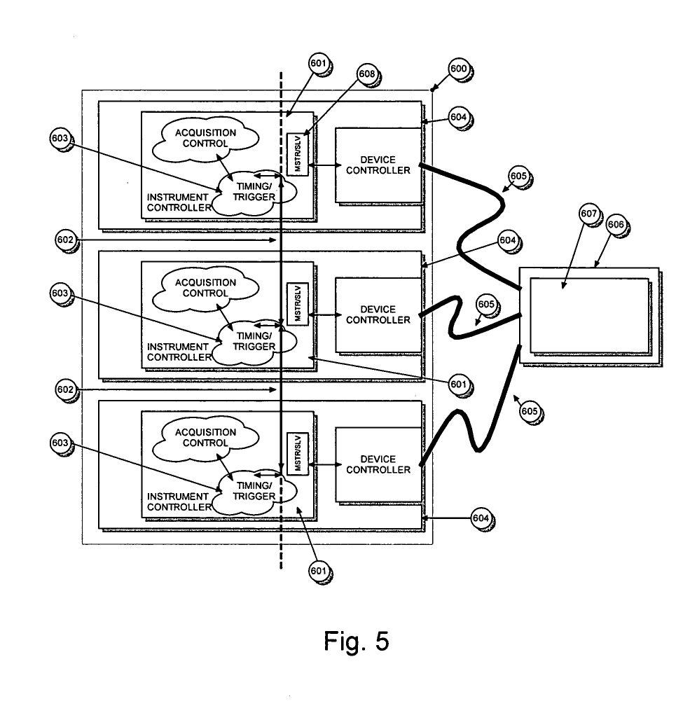

Another embodiment of the invention is illustrated in FIG. 5. In this embodiment, the discrete instruments 604 are provided with synchronization connectors, shown generally at 602, whereby synchronization signals can be communicated directly between the instruments 604. The discrete instruments 604 can thereby synchronize with each other, enabling a compound instrument 600 to be formed.

An enhanced instrument controller 601 can be provided to allow precise sharing of synchronization signals between the discrete instruments 604 using the synchronization connectors 602.

As before, the instrument controller 601 can be a device inside the instrument 604, which handles the timing and control of the discrete instrument 604 and its acquisition or output control functions. Again, the instrument controller 601 can be operable, using a locally generated timing clock source, which is used internally to sequence the events associated with the instrument's 604 function. As described above, an instrument such as an oscilloscope would typically require a clock to control an internal analogue-to-digital converter device, to effect data capturing from same, to control the movement of the data into a local memory, and to synchronize external events operable to trigger or gate the oscilloscope's capture and acquisition functions etc.

In this embodiment, the instrument controller 601 in each instrument 604 allows a master-slave arrangement for certain key signals, operable for the exchange of timing and synchronization information between instruments. These key signals are referred to herein as synchronization signals.

The software instrument driver 607 running on host computer 606 can configure each discrete instrument 604 via the USBs 605 as a master or as a slave 608. This can be achieved using commands sent according to the standard USB specification. One instrument is set as the master. The decision as to which instrument is set as the master can be made using an arbitrary, predetermined or user controlled method.

It is important to realize that in this embodiment, the USB connection 605 to each discrete instrument 604 is the primary means for control and monitoring of that single instrument 604. Thus, each USB 605 is dedicated to each respective discrete instrument 604. Accordingly, each discrete instrument is considered a USB device in its own right.

In this embodiment, the master-slave configuration causes the master instrument controller 601 to output a synchronization signal including its internal clock reference over the synchronization connection 602 of the master instrument 604. The instrument controllers 601 of the slave instruments 604 receive the synchronization signal via there synchronization connections, and synchronize with the master instrument 604 (and thus with the other slave instruments 604 also) using the synchronization signal.

Thus, the synchronization signal can be used for both the master instrument 604 and each of the slave instrument's 604 timing purposes.

According to one embodiment, the synchronization connection 602 includes a short interconnecting cable with a plurality of screened or unscreened conductors.

In another embodiment, the synchronization connection 602 can include a form of stacking plug and socket connectors, each having a plurality of conductors and arranged mechanically so that each discrete instrument could be stacked on top, or beside, the next, with the stacking connector plugs and sockets forming a plurality of continuous conductive paths through each and every instrument in the stack. In this way each discrete instrument can either drive or sense some combination of these signals.

In yet another embodiment, the synchronization connection 602 can include an optical fiber link.

In yet another embodiment, synchronization connection 602 can be by wireless means, using radio or optical techniques.

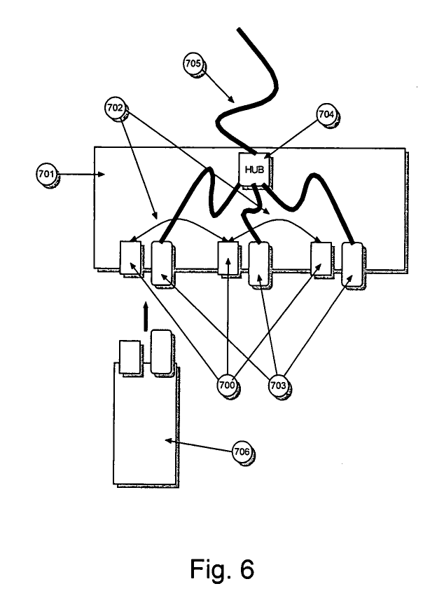

In some embodiments, the synchronization connection 602 can be provided by a back-plane arrangement of USB connectors. An example of this is shown in FIG. 6.

The back-plane 701 includes USB connectors 700 and additional connectors 703 which are arranged adjacent to each other and which are mechanically configured to connect to an inserted instrument 706 so that each pair of USB connectors 700 and additional connectors 703 connect to the instrument 706 at the same time. Each additional connector 700 connects with a synchronization connection of an instrument 706. The additional connectors 700 are coupled together 702 across the back-plane 701 to provide interconnection of the synchronization connections of each instrument inserted on the back-plane 701. The USB connectors 703 can connect to a local USB hub device 704 and thence to a single USB connection 705, or may pass through to USB cables or to further USB connectors to allow connection to external USB ports.

In the embodiments described above, each of the slave instruments can be configurable by the software instrument driver 607 at the host computer 606, so as to use the synchronization signal output by the master instrument on its synchronization connection 602. This arrangement therefore ensures that the synchronization signal arrives with minimal skew at each of the discrete instruments 604, so guaranteeing their operational concurrency and periodicity.

In accordance with an enhancement to the above scheme, the synchronization signal can include a trigger status signal to each of the other instrument controllers 601. This enhancement could, for example, use one or more interconnect channels via the interconnection means already described. More than one synchronization connection 602 can be provided on each instrument. In accordance with this example, the software instrument driver 607 at the host computer 606 could configure one or more nominated discrete instruments 604 to become operable to assert a shared trigger signal in response to some defined external condition, and hence cause all discrete instruments to trigger concurrently, thus acting as a single compound instrument 600.

For example, the software instrument driver 607 can nominate a first channel to act as master trigger channel. The software instrument driver 607 can additionally configure a plurality of slave discrete instruments to commence their acquisitions, and as a final step configure the master discrete instrument to commence its acquisition and to become sensitive to some trigger condition based on the measured signal on this master channel. On detecting the trigger event, the master instrument can be operable to assert the shared trigger signal, thereby to cause it, and all the other discrete instruments, to acquire an input signal (including, for example, measurement data) for some predefined time. The software instrument driver 607 can then unload from each discrete instrument the collected measurement data and render it on the host computer display, knowing that the first sample from each discrete instrument is related in time to the trigger moment signaled by the master discrete instrument.

In a further enhancement, the synchronization connections 602 can carry signals for relaying to the master device information for allowing the master device to detect the inter-connection of each slave device. The software instrument driver 607 can thereby interrogate the master instrument as to which discrete instruments are interconnected and which are not.

The synchronization connections 602 and any interconnects running therebetween can be implemented using a serial bus such as SPI, I2C, MicroWire etc., or may be means of a proprietary signaling scheme.

It is to be understood that a compound instrument could be realized having beneficial operation resulting from use of either an enhanced USB controller as described above in relation to FIGS. 3 and 4, or using a synchronization connections as described in relation to FIGS. 5 and 6, or by using both approaches in combination. Thus, it is envisaged, for example, that an instrument such as that illustrated in FIG. 3 can be provided with a synchronization connection, or that an instrument such as one of those shown in FIG. 5 can employ the additional bus address protocol described in relation to FIGS. 3 and 4. In this way, multiple instruments can be synchronized a synchronization signal produced by the master, in addition to the host computer being able to provide synchronization commands such as a trigger command to the master and each of the slaves.

As can be seen, the above disclosures provide a way to leverage the cost and performance advantages of USB as a means to connect discrete measurement or control instruments, and further can allow each discrete instrument to interact with others in a system to make them behave collectively as a single compound instrument. Resultantly, such a USB instrument becomes modular in nature, being operable on its own, or combined with others having similar enhancements.

While the invention has been illustrated using specific embodiments which employ the USB specification, it is envisaged that embodiments of the invention can provide for synchronization in systems which use other bus specifications. For the example, embodiments of the invention can be employed in systems which use a “tree” bus topology having dedicated bus segments corresponding to each discrete instrument.

1. A communications controller for an instrument connectable to a host computer via a bus, wherein the communications controller is operable to:
control communications between the instrument and the host computer according to an address-based protocol for a dedicated bus specification, and
respond to a received synchronization command having an address allocated to another instrument, by initiating a synchronization operation for synchronizing the instrument with the other instrument.

2. The controller of claim 1, wherein the synchronization operation comprises initiating data collection by the instrument on occurrence of a trigger event identified by the synchronization command.

3. The controller of claim 1 comprising a clock, wherein the synchronization operation comprises synchronizing the clock using a time indicator in the synchronization command.

4. The controller of claim 1, operable to control communications between the instrument and the host computer according to an address allocated to the instrument.

5. The controller of claim 1, operable to respond to one of a plurality of address allocated to other instruments to perform a synchronization operation.

6. The controller of claim 5, operable to determine which one of a plurality of synchronization operations to perform according to the address of the synchronization command.

7. The controller of claim 1 comprising a table with a plurality of address entries, wherein one or more of the address entries in the table is an address alias entry which identifies an address allocated to another instrument.

8. The controller of claim 1, operable to identify a class of the synchronization command, and to determine whether to respond to the synchronization command according to the class.

9. The controller of claim 1, where the dedicated bus specification is a Universal Serial Bus (USB) specification.

10. An instrument comprising a bus connector and communications controller for the instrument connectable to a host computer via a bus, wherein the communications controller is operable to:
control communications between the instrument and the host computer according to an address-based protocol for a dedicated bus specification, and respond to a received synchronization command having an address allocated to another instrument, by initiating a synchronization operation for synchronizing the instrument with the other instrument.

11. A computer program product comprising instructions executable to implement a communications controller for an instrument connectable to a host computer via a bus, wherein the communications controller is operable to:
control communications between the instrument and the host computer according to an address-based protocol for a dedicated bus specification, and
respond to a received synchronization command having an address allocated to another instrument, by initiating a synchronization operation for synchronizing the instrument with the other instrument.

12. The computer program product of claim 11 on a carrier medium.

13. A computer system comprising the instrument of claim 10, a host computer, and a dedicated bus connecting the instrument to the host computer.

14. A method for controlling communications via a bus, comprising:
controlling communications between an instrument and a host computer according to an address-based protocol for a dedicated bus specification; and
responding to a received synchronization command having an address allocated to another instrument, by initiating a synchronization operation for synchronizing the instrument with the other instrument.

15. An instrument for use with a host computer, the instrument comprising:
a bus connector configured to connect the instrument to a dedicated bus segment for communicating with the host computer; and
a synchronization connector for communicating a synchronization signal with another instrument,
wherein the instrument is operable to synchronize with the other instrument using the synchronization signal.

16. The instrument of claim 15, configurable as a master instrument operable to produce the synchronization signal and to transmit the synchronization signal to the other instrument via the synchronization connector.

17. The instrument of claim 15, configurable as a slave instrument responsive to the synchronization signal received from the other unit to perform a synchronization operation according to the synchronization signal.

18. The instrument of claim 15, wherein the synchronization signal comprises a timing signal for synchronizing clock of the instrument with a clock of the other instrument.

19. The instrument of claim 15, wherein the synchronization signal identifies a trigger event.

20. The instrument of claim 19, comprising one or more further connections for collecting measurement data and operable to begin collection of the measurement data in response to occurrence of the trigger event.

21. The instrument of claim 15, wherein the synchronization connector provides a plurality of synchronization channels.

22. The instrument of claim 15, comprising a plurality of synchronization connectors.

23. The instrument of claim 15, operable to communicate with the host computer using an address-based protocol for a dedicated bus specification.

24. The instrument of claim 15, wherein the bus connector is a Universal Serial Bus (USB) connector.

25. An instrument controller for controlling an instrument comprising:
a bus connector configured to connect the instrument to a dedicated bus segment for communicating with a host computer; and a synchronization connector for communicating a synchronization signal with another instrument, wherein the instrument controller is operable to control the instrument to synchronize with the other instrument by:
communicating a synchronization signal with an instrument controller of another instrument, and
synchronizing with the instrument controller of the other instrument using the synchronization signal.

26. A computer program product comprising instructions executable on an instrument to implement the instrument controller of claim 25 for use with a host computer, the instrument comprising:
a bus connector configured to connect the instrument to a dedicated bus segment for communicating with a host computer; and
a synchronization connector for communicating a synchronization signal with another instrument,
wherein the instrument is operable to synchronize with the other instrument using the synchronization signal.

27. The computer program product of claim 27 on a carrier medium.

28. A back-plane for receiving a plurality of instruments for use with a host computer, each of said instruments comprising:
a bus connector configured to connect the instrument to a dedicated bus segment for communicating with the host computer; and
a synchronization connector for communicating a synchronization signal with another instrument,
wherein the instrument is operable to synchronize with the other instrument using the synchronization signal,
the back-plane comprising a plurality of bus connectors and a plurality of respective synchronization connectors for receiving corresponding bus and synchronization connectors of the instruments, wherein the synchronization connectors of the back-plane are interconnected for conveying synchronization signals between received instruments.

29. The back-plane of claim 28, comprising a hub, wherein one more of the bus connectors are connected to the hub.

30. The back-plane of claim 28, wherein the bus connectors are Universal Serial Bus (USB) connectors.

31. A computer system comprising a host computer, an instrument for use with the host computer, and a dedicated bus connecting the instrument to the host computer, wherein the instrument comprises:
a bus connector configured to connect the instrument to a dedicated bus segment for communicating with the host computer; and
a synchronization connector for communicating a synchronization signal with another instrument,
wherein the instrument is operable to synchronize with the other instrument using the synchronization signal.

32. The computer system of claim 31 comprising a back-plane for conveying synchronization signals between instruments connected to the host computer, each of said instruments comprising:
a bus connector configured to connect the instrument to a dedicated bus segment for communicating with the host computer; and
a synchronization connector for communicating a synchronization signal with another instrument,
wherein the instrument is operable to synchronize with the other instrument using the synchronization signal,
the back-plane comprising a plurality of bus connectors and a plurality of respective synchronization connectors for receiving corresponding bus and synchronization connectors of the instruments, wherein the synchronization connectors of the back-plane are interconnected for conveying synchronization signals between received instruments.

33. The instrument of claim 15 comprising a communications controller operable to:
control communications between the instrument and the host computer according to an address-based protocol for a dedicated bus specification, and
respond to a received synchronization command having an address allocated to another instrument, by initiating a synchronization operation for synchronizing the instrument with the other instrument.

34. The instrument of claim 10, further comprising an instrument controller, wherein the instrument controller comprises:
a bus connector configured to connect the instrument to a dedicated bus segment for communicating with a host computer; and a synchronization connector for communicating a synchronization signal with another instrument, wherein the instrument controller is operable to control the instrument to synchronize with the other instrument by:
communicating a synchronization signal with an instrument controller of another instrument, and
synchronizing with the instrument controller of the other instrument using the synchronization signal.

35. A computer system comprising the instrument of claim 33, a host computer, and a dedicated bus connecting the instrument to the host computer.

36. The computer system of claim 35 comprising a back-plane for receiving a plurality of instruments for use with a host computer, each of said instruments comprising:
a bus connector configured to connect the instrument to a dedicated bus segment for communicating with the host computer; and
a synchronization connector for communicating a synchronization signal with another instrument,
wherein the instrument is operable to synchronize with the other instrument using the synchronization signal,
the back-plane comprising a plurality of bus connectors and a plurality of respective synchronization connectors for receiving corresponding bus and synchronization connectors of the instruments, wherein the synchronization connectors of the back-plane are interconnected for conveying synchronization signals between received instruments.

37. A computer system comprising the instrument of claim 34, a host computer, and a dedicated bus connecting the instrument to the host computer.

38. The computer system of claim 37 comprising a back-plane for receiving a plurality of instruments for use with a host computer, each of said instruments comprising:
a bus connector configured to connect the instrument to a dedicated bus segment for communicating with the host computer; and
a synchronization connector for communicating a synchronization signal with another instrument,
wherein the instrument is operable to synchronize with the other instrument using the synchronization signal,
the back-plane comprising a plurality of bus connectors and a plurality of respective synchronization connectors for receiving corresponding bus and synchronization connectors of the instruments, wherein the synchronization connectors of the back-plane are interconnected for conveying synchronization signals between received instruments.

39. A method comprising:
connecting a first instrument through a bus connector to a dedicated bus segment communicating with a host computer; and
communicating a synchronization signal with a second instrument through a synchronization connector, wherein the first instrument synchronizes with the second instrument using the synchronization signal.
